(19) United States
(12) Patent Application Publication
(10) Pub. No.: US 2003/0201837 A1
(43) Pub. Date: Oct. 30, 2003

(54) Modulating module incorporating a harmonically distorted modulator, and frequency shifting module with a harmonic mixer

(75) Inventors: Wei Ma, Hsi-An City (CN); Mark Liang, Pa-Te City (TW)

Correspondence Address: MERCHANT & GOULD PC, 3200 IDS CENTER, 80 SOUTH EIGHTH STREET, MINNEAPOLIS, MN, 55402-0903, US

(73) Assignee: Chung-Hsin Electric & Machinery Mfg. Corp., Chung-Ho City (TW)

(21) Appl. No.: 10/193,633

(22) Filed: Jul. 9, 2002

(30) Foreign Application Priority Data
Apr. 30, 2002 (TW) 091108941

(51) Int. Cl. H04B 1/10

(52) U.S. Cl. 331/74; 455/323; 455/317; 455/295; 455/307

(57) ABSTRACT

A modulating module includes a modulator unit having a harmonically distorted modulator output adapted to be modulated by an input signal and containing a fundamental frequency component and harmonic frequency components, a power amplifier connected to the modulator unit, and a filter unit connected to the power amplifier for filtering the modulator output so as to permit only one predetermined harmonic frequency component to pass therethrough. In addition, a mixer device of a frequency shifting module includes a mixer unit adapted to receive an input signal with an input frequency, and a local oscillator connected to the mixer unit for generating an oscillator output with a local frequency. The mixer device mixes the input signal with a predetermined harmonic order of the oscillator output to result in an output signal with an intermediate frequency.

### CROSS-REFERENCE TO RELATED APPLICATION

This application claims priority of Taiwanese Application No. 091108941, filed on Apr. 30, 2002.

### BACKGROUND OF THE INVENTION

1. Field of the Invention

The invention relates to microwave signal transceivers, more particularly to a modulating module that incorporates a harmonically distorted modulator, and a frequency shifting module with a harmonic mixer, the modulating module and the frequency shifting module being suitable for use in a microwave signal transceiver.

2. Description of the Related Art

Referring to FIG. 1, a conventional signal transmitter 1 is shown to include a video signal processor 11, an audio signal processor 12, an oscillator/modulator 13, a power amplifier 14, and a filter 15. The oscillator/modulator 13 has a modulator output modulated by composite signals from the video signal processor 11 and the audio signal processor 12. The modulator output contains a fundamental frequency component and a plurality of harmonic frequency components. The modulator output is then amplified by the power amplifier 14 and is processed by the filter 15 to remove the harmonic frequency components and to permit only the fundamental frequency component to pass therethrough.

Referring to FIG. 2, a conventional signal receiver 2 is shown to include a receiver antenna 20, a low-noise signal amplifier 21, a filter 22, a mixer 23, and an oscillator 24. The signal amplifier 21 receives and amplifies signals from the receiver antenna 20. The filter 22 removes spurious signals from the output of the signal amplifier 21. The mixer 23 mixes an input signal from the filter 22 with an oscillator output from the oscillator 24 so as to result in an intermediate frequency signal.

In the aforesaid signal transmitter 1, the oscillator/modulator 13 performs frequency modulation. The filter 15 removes the harmonic frequency components so that only the fundamental frequency component is transmitted with greater power. Frequency modulation techniques are also employed in the signal receiver 2. As stated above, the mixer 23 mixes the filter signal with the oscillator output to result in the intermediate frequency signal.

The aforesaid signal transmitter 1 is currently used in the conversion of input signals to 2.4+Δf GHz microwave signals for transmission in the 2.4 GHz ISM frequency band. As a result, the corresponding signal receiver 2 is designed to receive microwave signals transmitted in the 2.4 GHz ISM frequency band. If transmission in the 5.8 GHz ISM frequency band is desired, the oscillator/modulator 13 in the signal transmitter 1 and the oscillator 24 in the signal receiver 2 must be replaced accordingly with 5.8 GHz oscillators. However, since such high frequency oscillators are very expensive, they are not in wide use in the industry.

In view of rapid developments in the communications industry, more and more communications apparatus are being designed for the 2.4 GHz ISM frequency band, e.g. apparatus complying with the Bluetooth transmission standard, microwave ovens, etc. Therefore, the aforesaid audio-video signal transmission scheme is prone to signal interference. This situation is further aggravated by the relatively narrow bandwidth of 83.5 MHz permitted in the 2.4 GHz ISM frequency band, which does not allow the simultaneous use of four channels for fear of interference among neighboring channels.

Therefore, there is an urgent need to develop some technique for the modulation of audio-video signals into higher frequency microwave signals suitable for transmission and reception in the 5.8 GHz ISM frequency band instead of the lower 2.4 GHz ISM frequency band using low-cost signal transmitters and signal receivers so as to solve the problems of insufficient transmission bandwidth and signal interference.

### SUMMARY OF THE INVENTION

Therefore, the main object of the present invention is to provide a relatively low-cost modulating module for use in a microwave transceiver to permit signal transmission at higher frequencies.

Another object of the present invention is to provide a relatively low-cost frequency shifting module for use in a microwave transceiver to permit signal reception at higher frequencies.

According to one aspect of the invention, a modulating module comprises:

a modulator unit having a harmonically distorted modulator output adapted to be modulated by an input signal, the modulator output containing a fundamental frequency component and a plurality of harmonic frequency components;

a power amplifier connected to the modulator unit for amplifying the modulator output; and

a filter unit connected to the power amplifier for filtering the modulator output so as to permit only a predetermined one of the harmonic frequency components of the modulator output to pass therethrough.

According to another aspect of the invention, a frequency shifting module comprises:

a mixer device including a mixer unit adapted to receive an input signal with an input frequency, and a local oscillator connected to the mixer unit for generating an oscillator output with a local frequency, the mixer device mixing the input signal with a predetermined harmonic order of the oscillator output to result in an output signal with an intermediate frequency;

a filter device connected to the mixer device for filtering noise signals from the output signal; and

a gain amplifier connected to the filter device for amplifying the output signal.

### BRIEF DESCRIPTION OF THE DRAWINGS

Other features and advantages of the present invention will become apparent in the following detailed description of the preferred embodiments with reference to the accompanying drawings, of which:

FIG. 1 is a schematic circuit block diagram illustrating a part of a conventional signal transmitter;

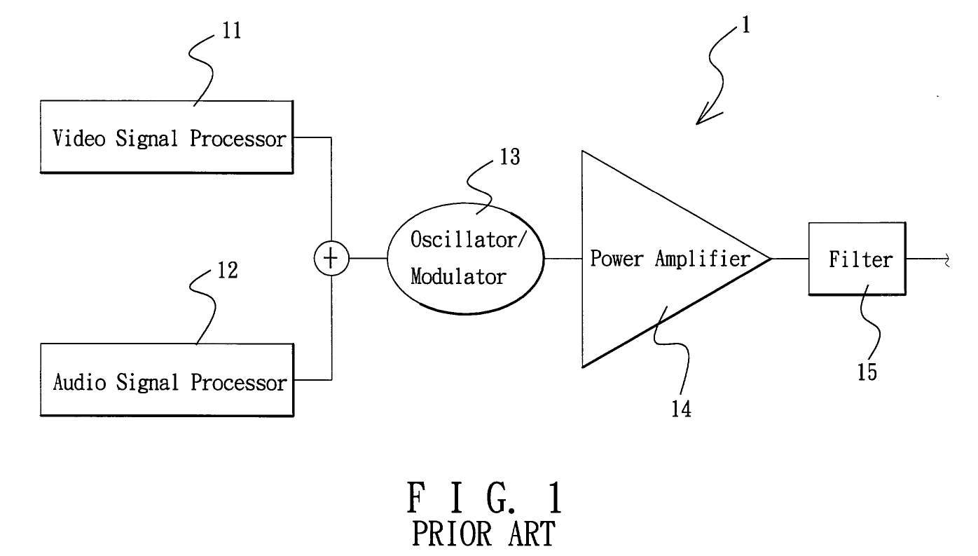

FIG. 2 is a schematic circuit block diagram illustrating a part of a conventional signal receiver;

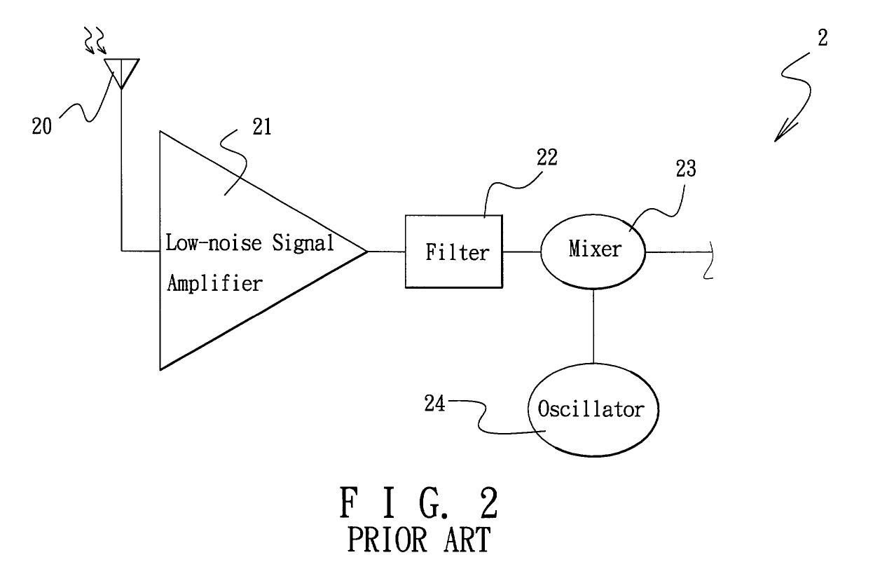

FIG. 3 is a schematic circuit block diagram of a signal transmitter that incorporates the preferred embodiment of a modulating module according to the present invention; and

FIG. 4 is a schematic circuit block diagram of a signal receiver that incorporates the preferred embodiment of a frequency shifting module according to the present invention.

### DETAILED DESCRIPTION OF THE PREFERRED EMBODIMENTS

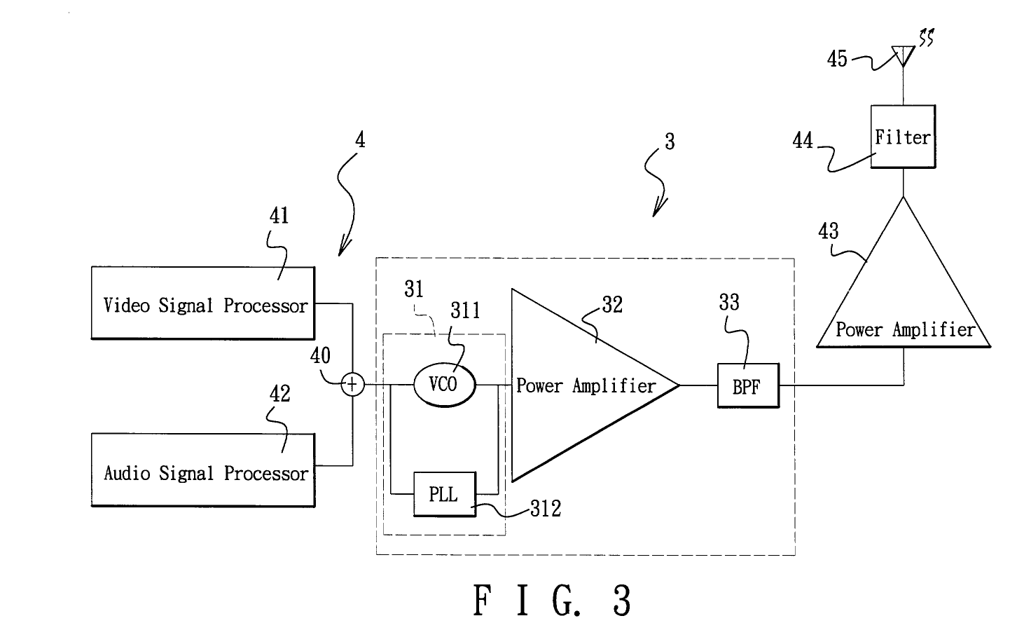

Referring to FIG. 3, the preferred embodiment of a modulating module 3 according to the present invention is shown to be adapted for use in an audio-video microwave signal transmitter 4. The modulating module 3 is disposed between a power amplifier 43 and a combiner 40 which combines signals from a video signal processor 41 and an audio signal processor 42. The modulating module 3 is used to convert the input signal from the combiner 40 to a 5.8+Δf GHz microwave signal which is to be amplified by the power amplifier 43 for subsequent transmission in the 5.8 GHz ISM frequency band by a transmitter antenna 45. For abbreviation, in the following statements, a 5.8 GHz microwave signal is defined as a 5.8+Δf GHz microwave signal to be transmitted in the 5.8 GHz ISM frequency band, a 2.4 GHz microwave signal is defined as a 2.4+Δf GHz microwave signal to be transmitted in the 2.4 GHz ISM frequency band, and a 2.9 GHz microwave signal is defined as a 2.9+Δf GHz microwave signal, where Δf is the frequency modulation shift.

In the audio-video microwave signal transmitter 4, the video signal processor 41 pre-emphasizes and amplifies video signals. The audio signal processor 42 pre-emphasizes and amplifies audio signals that modulate 6.0 MHz and 6.5 MHz auxiliary carriers. The signals from the signal processors 41, 42 are provided to the combiner 40 to result in a composite input signal to be processed by the modulating module 3.

In this embodiment, the modulating module 3 includes a modulator unit 31, a power amplifier 32 connected to the modulator unit 31, and a filter unit 33 connected to the power amplifier 32.

The modulator unit 31 has a harmonically distorted modulator output to be modulated by the composite input signal from the combiner 40. The modulator output contains a 2.9 GHz fundamental frequency component, a 5.8 GHz second harmonic frequency component, an 8.7 GHz third harmonic frequency component, etc. The modulator unit 31 includes a 3.0 GHz voltage-controlled oscillator (VCO) 311 and a phase-locked loop (PLL) 312 connected to the VCO 311. The PLL 312 outputs a control voltage to control the oscillating frequency output of the VCO 311 so as to stabilize the fundamental frequency component of the modulator output.

The modulator output is provided to the power amplifier 32 for amplification and is subsequently processed by the filter unit 33.

The filter unit 33 is a band pass filter (BPF) in this embodiment. The filter unit 33 filters the modulator output so as to permit only a predetermined one of the harmonic frequency components of the modulator output to pass therethrough. In the preferred embodiment, the 5.8 GHz second harmonic frequency component is the predetermined harmonic frequency component. Thus, the fundamental frequency component and the remaining harmonic frequency components of the modulator output are filtered out by the filter unit 33. At this stage, it is evident that conversion of audio-video input signals to 5.8 GHz microwave signals can be accomplished in this invention without the need for a 5.8 GHz oscillator.

The output of the filter unit 33 is provided to the power amplifier 43 of the audio-video microwave signal transmitter 4 for amplification, and is subsequently provided to a filter 44 that is connected to the power amplifier 43 for filtering out noise signals. Finally, the filtered output is sent to the transmitter antenna 45 that is connected to the filter 44 for transmission as 5.8 GHz microwave signals. It is apparent that this invention can solve the problems of insufficient bandwidth and signal interference because the 5.8 GHz ISM frequency band is allocated with a 100 MHz bandwidth ranging between 5725 MHz and 5825 MHz, which is larger than that of the conventional 2.4 GHz frequency band and which allows simultaneous use of four channels.

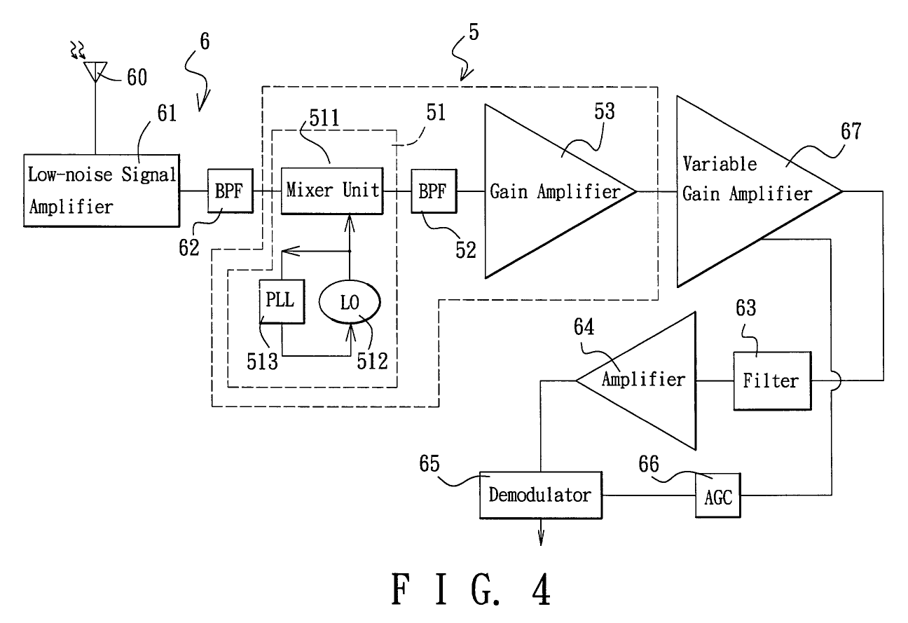

Referring to FIG. 4, the preferred embodiment of a frequency shifting module 5 according to the present invention is shown to be adapted for use in an audio-video microwave signal receiver 6. The frequency shifting module 5 is disposed between a band pass filter (BPF) 62 and a variable gain amplifier 67 so as to convert 5.8 GHz microwave signals from the band pass filter 62 into intermediate frequency signals to be provided to the variable gain amplifier 67.

In the audio-video microwave signal receiver 6, a receiver antenna 60 is used to receive 5.8 GHz ISM frequency band signals, and a low-noise signal amplifier 61 is connected to the receiver antenna 60 for amplifying the antenna signals. The BPF 62 is connected to the low-noise signal amplifier 61 and filters spurious signals from the amplifier output. The filtered output is then provided to the frequency shifting module 5.

The frequency shifting module 5 includes a mixer device 51, a filter device 52 connected to the mixer device 51, and a gain amplifier 53 connected to the filter device 52. The mixer device 51 includes a harmonic mixer unit 511, a local oscillator (LO) 512 in the form of a voltage-controlled oscillator that is connected to the mixer unit 511, and a phase-locked loop (PLL) 513 connected to the local oscillator 512. The PLL 513 serves to stabilize a local frequency of an oscillator output of the LO 512 to between 2.6 GHz and 2.8 GHz and to result in a plurality of harmonic frequency components, each of which is a multiple of the local frequency. One of the harmonic frequency components is the second harmonic frequency component ranging between 5.2 GHz and 5.6 GHz. In this embodiment, the mixer unit 511 removes the local frequency component from the oscillator output of the local oscillator 512, and mixes a 5.8 GHz input microwave signal from the BPF 62 with the second harmonic frequency component from the local oscillator 512 so as to result in an output signal with an intermediate frequency of 479.5 MHz.

At this stage, the output of the mixer unit 511 not only contains the output signal with the intermediate frequency of 479.5 MHz, but also contains noise signals, such as the 5.8 GHz microwave signal, signals with other harmonic frequency components, and signals resulting from the mixing of the 5.8 GHz microwave signal with the other harmonic frequency components. The filter device 52 is in the form of a band pass filter (BPF) for filtering the noise signals from the intermediate frequency output signal.

The gain amplifier 53 amplifies the intermediate frequency output signal from the filter device 52. The output of the gain amplifier 53 is provided to the other circuits of the audio-video microwave signal receiver for processing, such as the variable gain amplifier 67, a surface audio wave (SAW) filter 63 connected to the variable gain amplifier 67, an amplifier 64 connected to the SAW filter 63, and a demodulator 65 connected to the amplifier 64. An automatic gain control unit 66 is connected between the demodulator 65 and the variable gain amplifier 67 to control the amplifier gain. The aforesaid circuits cooperate to convert the intermediate frequency output signals to base frequency audio-video signals in a known manner.

Due to transmission using the wider 5.8 GHz ISM frequency band, channel spacing can be made larger. Therefore, the band pass filter 62 in the audio-video microwave signal receiver 6 can filter signals from other channels more easily, thus greatly diminishing the problem of signal interference.

While the predetermined harmonic frequency component used in the foregoing embodiments is the second harmonic frequency component, it should not be limited thereto. The third, fourth, and other higher order harmonic frequency components may be used in actual practice. Moreover, it should be noted that the technique disclosed in this invention can also be applied to the transmission and reception of signals via the other bands in the frequency spectrum other than the microwave band.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

We claim:

1. A modulating module comprising:
a modulator unit having a harmonically distorted modulator output adapted to be modulated by an input signal, the modulator output containing a fundamental frequency component and a plurality of harmonic frequency components;
a power amplifier connected to said modulator unit for amplifying the modulator output; and
a filter unit connected to said power amplifier for filtering the modulator output so as to permit only a predetermined one of the harmonic frequency components of the modulator output to pass therethrough.

2. The modulating module as claimed in claim 1, wherein said modulator unit includes a voltage-controlled oscillator.

3. The modulating module as claimed in claim 2, wherein said modulator unit further includes a phase-locked loop connected to said voltage-controlled oscillator to stabilize the fundamental frequency component of the modulator output.

4. The modulating module as claimed in claim 1, wherein said filter unit is a band pass filter.

5. The modulating module as claimed in claim 1, wherein the input signal is an audio-video signal.

6. The modulating module as claimed in claim 1, wherein the predetermined one of the harmonic frequency components is in the microwave range.

7. A frequency shifting module comprising:
a mixer device including a mixer unit adapted to receive an input signal with an input frequency, and a local oscillator connected to said mixer unit for generating an oscillator output with a local frequency, said mixer device mixing the input signal with a predetermined harmonic order of the oscillator output to result in an output signal with an intermediate frequency;
a filter device connected to said mixer device for filtering noise signals from the output signal; and
a gain amplifier connected to said filter device for amplifying the output signal.

8. The frequency shifting module as claimed in claim 7, wherein said local oscillator is a voltage-controlled oscillator.

9. The frequency shifting module as claimed in claim 7, wherein said mixer device further includes a phase-locked loop connected to said local oscillator to stabilize the local frequency of the oscillator output.

10. The frequency shifting module as claimed in claim 7, wherein the input signal is a microwave signal.
